(19) United States
(12) Patent Application Publication
(10) Pub. No.: US 2014/0274302 A1
(43) Pub. Date: Sep. 18, 2014

(54) WAGERING SYSTEM WITH DIFFERENTIAL COMMISSIONS

(71) Applicant: Richard A. Herbert, Riverside, IL (US)

(72) Inventor: Richard A. Herbert, Riverside, IL (US)

(21) Appl. No.: 14/218,248

(22) Filed: Mar. 18, 2014

Related U.S. Application Data
(60) Provisional application No. 61/802,821, filed on Mar. 18, 2013.

(51) Int. Cl. G07F 17/32

(52) U.S. Cl. CPC G07F 17/326
USPC 463/22

(57) ABSTRACT

A wagering system having a processor operatively connected to a random number generator that has a wagering base with at least first and second different information that is each accessed by an input wager. The random number generator is configured so that a probability of accessing the first information through an input wager is higher than a probability of accessing the second information. The processor is programmed to identify: a) one return for an input wager that accesses the first information; and b) a second higher return for an input wager that accesses the second information. The processor is programmed to factor in a higher percentage commission for one of the first and second returns than a percentage commission for the one return.

### CROSS-REFERENCE TO RELATED APPLICATIONS

This application is a non-provisional of application Ser. No. 61/802,821, filed Mar. 18, 2013.

### BACKGROUND OF THE INVENTION

1. Field of the Invention

This invention relates to wagering systems that process input wagers and identify different returns for wagers based upon different winning probabilities and, more particularly, to a wagering system with a processor that additionally factors in commissions on returns.

2. Background Art

Currently Penny Video Slot Machines dominate the Fixed Odds Slot Industry. They operate at a relatively high take out commission, in the states outside Nevada, of approximately 12% (the “Take”). Clearly, these are very lucrative devices which yield much larger revenues than the industry's older style machines; the Electro-Mechanicals. The Fixed Odds Slot Industry is able to receive this higher yields because these Penny Video Slot Machines offer far greater entertainment value to the players. This trade off of more revenue for greater entertainment (video animation, sound effects, and entertaining games within games), i.e., Bonus Rounds, is termed “Time On The Machine”. But due to laws and regulations governing the Fixed Odds Slot Industry, the approximate 12% commission (Take) is built into the Fixed Odds Slot Machine's “Chip”. The Chip determines, in conjunction with a random number generator and microprocessor, whether the player wins or loses and then how much the win is. The “Win” can range from just a fraction of the bet made (really a not total loss) to any amount up to the top jackpot offered. Fixed Odds Slots have this commission built in and cannot, under the current regulations and their current technologies, vary the commissions leveled as to the different individual jackpots offered.

There is, however, a newer technology that produces games that play similar to Fixed Odds Slots: Historical Racing Devices as described in U.S. Pat. Nos. 5,888,136 and 6,152,822 (the “Herbert Patents”) and U.S. Pat. Nos. 6,358,150 and 6,450,887, assigned to RaceTech. At the end of a night's play, seven different players under current technology for both Historical Racing Devices and Fixed Odds Slots might have the following results: won $3,260, won $1,200, won $653, won $41, lost $148, lost $643, lost $695. Yet each player, if we examine each and every play made, would have been subjected to a “PC” (percentage disadvantage) of 12% on each of the multitude of bets that each made throughout their session.

### SUMMARY OF THE INVENTION

The purpose of this invention is to teach a methodology whereby distinct commission levels can be leveled against different offered jackpots both in Historical Racing Devices as well as Fixed Odds Slots. This is unique and serves an important purpose for both type devices.

In one preferred form, the invention shifts the “commission burden” and preferably toward the jackpots that offer very high odds (low probability) and away from the jackpots that offer very low/moderate odds (higher probability). The net effect will prove neutral to the devices overall take (commission of 12% here exampled), but will dampen the large payouts but equally enhance the smaller payouts on an accounting basis. The net effect might look like this. Using our seven exemplary players above: won $2,900, won $1,109, won $510, won $59, lost $130, lost $384, lost $396. In both cases, the net win of the seven players totals $3,668, but when applying differential commissions to both Fixed Odds Slots and Historical Racing Pari-mutuel Devices we see a shift effect caused by a differential application of commissions to different offered jackpots. This is because the commissions on large jackpots are higher and the commissions on small jackpots are lower.

In one form, the invention is directed to a wagering system having a processor that is operably connected to a random number generator that has a wagering base. The wagering base has at least first and second different information and each is accessed by an input wager. The random number generator is configured so that a probability of accessing the first information through an input wager is higher than a probability of accessing the second information through an input wager. The processor is programmed to identify: (a) one return for an input wager that accesses the first information; and (b) a second return for an input wager that accesses the second information. The second return is higher than the one return. The processor is programmed to factor in a percentage commission in identifying the one and second returns. The processor is programmed to factor in a higher percentage commission for the second return than a percentage commission for the one return.

The invention is also directed to a method of processing returns on wagers that are input to a random number generator to access different information in a wagering base. The method includes the steps of: receiving a plurality of input wagers; processing the input wagers and identifying whether the input wagers access the information in the wagering base; and identifying returns for first and second input wagers that respectively access first and second different information in the wagering base. The step of identifying returns further involves factoring in a percentage commission that is different for the returns for the first and second input wagers.

In one form, the probability of accessing the first and second different information is different for the first and second input wagers.

### BRIEF DESCRIPTION OF THE DRAWINGS

FIG. 1 is a schematic representation of a wagering system according to the present invention; and

FIG. 2 is a flow diagram representation of a method of processing returns on wagers, according to the present invention.

### DETAILED DESCRIPTION OF THE PREFERRED EMBODIMENT

Initially, the invention will be described as applied to Historical Racing, and subsequently as applied to fixed odds slot machines. Historical Racing devices are described in the two aforementioned Herbert Patents, with the disclosures therein in their entirety being incorporated herein by reference. In conventional pari-mutuel wagering in racing, there are multiple types of offered wagers. With Historical Racing, if one is offered multiple wagering pools to wager into, different commission rates can be applied depending on the pool offered. For instance, if a win pool bet is offered, perhaps a commission of 5% could be applied. If place and show pools are also offered, perhaps these pools could have an applied commission of 4%. Perfecta pools say 9%, Trifectas say 12%, Superfectas say 16%, Pick Fours say 18%, High Fives say $20%, Pick Fives say 24%, Pick Sixes say 27%, Pick Nines say 35%, Twin Pick Sixes say 38%. Any larger progressive may be 39-40%. In such a manner, differential commissions can be applied and then tested to yield an overall percentage take of 12% or any desired number the owners and regulators wish to apply to the game. Currently a fixed take percentage is applied in Historical Racing that is the same no matter what the player is wagering on. There is no difference depending on any different bets.

In one preferred form, the inventive methodology will shift the commission burden, in general, onto players who were lucky enough to win the larger paying jackpots. The night's losing players, in general, will be found to not have won the larger paying jackpots and their wins will be found to be more generally confined to the smaller winning jackpots which under the inventive methodology will have lighter commissioned pools. The net effect will be such that these players will tend to “last longer” with any given bankroll than if they were playing a now existing pari-mutuel Historical Racing Device where the commission is applied evenly. These players will last longer, even if they eventually lose their entire playing stake. Others may lose less, in general, than they would have lost if they had played a Historical Racing Device with an evenly applied commission. There is no free lunch here, however. The Historical Racing device owners will procure the same 12% take, but the night's big winners will have footed a somewhat larger share of the bill. An individual who got lucky and won a big jackpot might win $3,200, whereas if he/she had won a like jackpot on a Historical Racing Device with evenly applied commissions that night, he/she might have won $3,600. This is a methodology to shift an evenly applied commission over to a commission more heavily applied, preferably to larger, higher odds jackpots (and by association to those players who win such jackpots). This is completely novel to any mechanical device Historical Racing game and any fixed odds device. While this described commission allocation is preferred, the invention contemplates other variable commission applications as based on other than probabilities to promote interest in a wagering system.

The following is an adaptation that can be used to bring this methodology into the fixed odds slot industry. In fixed odds slots, the same effects will occur with the inventive “differential commissions”. Here too, the “churn” will be increased as more money tends to stay on the gambling floor rather than be sequestered into the pockets of large jackpot winners. And because the house “PC” or take times the total money bet yields the hold, the overall effect (on fixed odds slots as well as with Historical Racing) on both types of devices will be to slightly increase the hold while concurrently fostering the perception by the players on the floor that the “slots are loose”. This is remarkable, as this methodology extracts a slightly larger profit from the players while simultaneously leaving the players with the perception that the devices are “loose”. What would actually happen with both fixed odds and Historical Racing Devices employing differential commission, is that overall machine play is increased slightly allowing for more money bet to fall to the house hold. Without differential commissions, winners and play evaporates on the floor more quickly. With differential commission, some of the money that would have left the floor in the pockets of the big winners instead stays in the hands of less fortunate players that night who tend to replay that money into the devices. They last longer while perhaps still losing their bankroll, thus perceiving the devices are “looser”, and that money that would have left with the big winners is instead transferred to those players who continue to play longer into the night and eventually lose that money to the house. The gambling floor stays busy a bit longer with more players hanging on but eventually the extra money taken from the big winners, by differential commissions, is temporarily transferred to the less lucky players of the night only to eventually be played into the devices and increasing the night's hold. This leaves the players doing the extra playing with the feeling that they got more action out of their bankroll than if they had played devices without differential commission, i.e. these machines are looser.

A close look at the mathematical theory behind differential commissions as applied to both the Pari-Mutuel Historical Racing Devices and Fixed Odds slots is in order. We know that even with this methodology and the supporting theory, if the players involved and the devices were to remain in place for an extended period of time, and millions and millions of plays were to be made, eventually the losses would predominate and there would be no winners. After a long, long time, everyone would end up losing very close to an amount equal to (in this 12% take example), 12% of each and every bet they made. One wrinkle needs explanation. If the players have a choice of which pools they wish to bet into, in both pari-mutuel Historical Racing and Fixed Odds Slots, then those pools selected by the players and the associated commission tied to those pools will determine their statistical percentage loss after a multitude of plays extended over a long period of time. But, if all the bets are randomly sent to pools with different commission rates, then one can predict what the ultimate loss percentage for each player is likely to be only over an extended play period and only by knowing the pool commission average rates. Now, if the bets are some admixture of the above two (choice and random), one would not be able to predict the loss percentage without knowing the exact distribution of bets made into the pools of differing commissions.

With Historical Racing, the inventive methodology is straightforward—simply assign the desired commission rates to the different pools offered and then adjust to the player's betting patterns if there is a mixture of random bet assignment and choice of pools the players may have the ability to choose to bet into, until the desired overall take is obtained. This take may slightly vary from time to time by changes in betting patterns of the players at different times and on rare occasion by statistical anomalies. With Fixed Odds Slots, the following particular changes to the current system need to be made to be able to utilize differential commissions: currently, Fixed Odds Slots employ a random number generator which selects a number from a universe of installed possible results. We can use for illustration here a universe of numbered results of 100,000. Now, if we would happen to achieve a “perfect cycle” of the random number generator, we would make 100,000 plays of say $1, and then each and every one of the possible 100,000 numbers would come up just once. If the top prize associated with one of the 100,000 available numbers was say $5,000, and the lowest prize associated with many of the available 100,000 numbers was 500, and many various prizes in between were tied to some of the 100,000 numbers, and many “nothing back” results were tied to all the rest of the 100,000 numbers, then by adding up all the 50¢ through the $5,000 the prizes might total $88,000. This would give us a play in total of $100,000 and a payout total of $88,000. This is a 12% take. This device played over extended time will yield a 12% profit of the gross play.

To adjust the foregoing system to employ differential commissions within a Fixed Odds Slot, we do the following: divide the single group of 100,000 numbers, corresponding each to a result, into groups of various composition (any of various divisions may be used). Note, the divisions are based on a range of numbers corresponding to prize value. The smaller value prizes are commissioned at 3%; while the highest are commissioned at 25%.

Group 1

| | |
|---|---|
| $5 Top Prize | Commission Rate 3% |
| ~35,000 #s | |

Group 2

| | |
|---|---|
| $10 Top Prize | Commission Rate 4% |
| ~25,000 #s | |

Group 3

| | | |
|---|---|---|
| $25 Top Prize | Commission Rate 8% | Net 12% Take |
| ~20,000 #s | | of all groups |
| | | (1, 2, 3, 4, 5) combined |

Group 4

| | |
|---|---|
| $75 Top Prize | Commission Rate 20% |
| ~15,000 #s | |

Group 5

| | |
|---|---|
| $5,000 Top Prize | Commission Rate 25% |
| ~5,000 #s | |

Note: The particular composition chosen for each group will have effects on the shifting of commission burden which can be engineered to suit the operators and the regulators of a particular jurisdiction. The top prizes within each group are indicated above, but lesser prizes reside within the groups. For example, first group $0-$5.00, second group $5.01-$10.00, third group $10.01-$25.00, fourth group $25.01-$75.00, and fifth group $75.01-$5,000.00. Note: many numbers within each group are of zero value.

Next, the player's bets are randomly assigned (an alternative is to allow the player to choose the assignment) to the available (here) 5 groups. This assignment takes place with a bet of, say, $2.00 divided into many packets of money ranging say from 1¢ to perhaps 10¢. Note: a player choosing from this example of five groups can apply an element of skillful play by choosing lower commissioned groups.

Then each bet is played within the group it randomly landed in (or alternatively chosen by the bettor) against the universe of numbers residing within the group by the random number generator.

In such a manner, when a player gambles for only a few to several hours, a different betting bias will form than is usual in Fixed Odds Slots. Certainly, should the players stay in place for a huge number of plays, the bias will vanish. But if players stay for a usual 2-6 hour gambling period, this methodology will tend to shift the burden of higher commissions to those players that had a heavier proportion of their bets land into groups 4 and 5 in my illustration. Of note is the fact that if these players had a heavier share of their bets land in groups 4 and 5 (for whatever reason: choice or chance), then they would also tend to have won bigger top jackpots than other players. The net result will be as discussed earlier. These players will shoulder a large burden of the commissions taken but also tend to be the winning players because they won a large jackpot since they had more opportunities to do so than other players. Conversely, players who by chance or choice (if available) had more of their bets land in groups 1, 2, 3 will tend to be playing overall against a smaller commission, but also they will tend to have fewer large wins and will tend not to be big winners. Yet their bankroll will stretch out over a longer time span due to the smaller effective take they encounter. These volatility “excursions” will lessen and dissolve in proportion to the time spent betting but will remain significant for several hours of play for both groups. Chance will, of course, produce anomalies among all these players, but these trends will form for significant numbers of players. Ultimately this is a tool to create increased volatility for a time period corresponding to usual play periods of slot (and Historical Racing) players.

An important point to emphasize in teaching this methodology is to point out that the groups of numbers (in our example 100,000 numbers) when divided into 5 groups (our example), should have more groups below the nominal 12% take than above it. The blended take can still be adjusted to yield the 12% example with only two groups above 12% and three groups below 12%, because the take can be set as high as needed in the lesser number of groups that exist at a higher commission than 12%. This promotes some persistence of subgroups of players playing against a lesser take for several hours. The chance distribution of a player's bet, if favored by the higher number of lower take pools available to receive these bets, allows for the persistence of this subgroup of gamblers for several hours. Of further note, in both Historical Racing and Fixed Odds Slots, is that if player choice is allowed and players heavily elect to contest bets offering higher jackpots, but also with a higher take, the net effect will be to drive house take and hold up.

One exemplary wagering system, according to the present invention, is shown at 10 in FIG. 1. The wagering system 10 is shown in schematic form to encompass virtually a limitless number of different variations of the individual components and their interaction. Among those variations are those specifically described in the two Herbert Patents identified above and, incorporated herein by reference.

The wagering system 10 includes a processor 12 that is operatively connected to a random number generator 14, which may be integrally formed with the processor 12 or a separate component. The random number generator 14 has a wagering base 16 with different information 18 that is accessed by a wager made from at least one, or from multiple, wagering terminals 20, 22. While in this embodiment, two terminals 20, 22 are shown, it is contemplated that potentially a very large number of terminals 20, 22 might make up the system 10. Each wagering terminal 20, 22 has an appropriate input, respectively 24, 26, to access the random number generator 14.

The random number generator 14 is programmed so that a probability of accessing first of the information 18 through an input wager is higher than a probability of accessing second of the information 18 through an input wager. The processor 12 is configured to identify: (a) one return for an input wager that accesses the first information; and (b) a second return for an input wager that accesses the second information. The second return is higher than the one return. The processor 12 is programmed to factor in a percentage commission in identifying the one and second returns. In a preferred form, the processor 12 is programmed to factor in a higher percentage commission for the second return than a percentage commission for the one return. As noted above, this allocation of commission is not to be viewed as limiting.

With the inventive wagering system 10, a method of processing returns on wagers that are input to the random number generator 14 to access the different information 18 in the wagering base 16 can be carried out as shown in flow diagram form in FIG. 2.

More specifically, as shown at block 28, a plurality of input wagers are received.

At block 30, the input wagers are processed to identify whether the input wagers access the information in the wagering base.

As shown at block 32, returns are identified for first and second input wagers that respectively access first and second different information on the wagering base. The step of identifying returns further involves factoring in a percentage commission that is different for the returns for the first and second input wagers.

In one exemplary form, the probability of accessing the first and second different information is different for the first and second input wagers.

The foregoing disclosure of specific embodiments is intended to be illustrative of the broad concepts comprehended by the invention.

1. A wagering system comprising:
a processor,
the processor operatively connected to a random number generator that has a wagering base,
the wagering base comprising at least first and second different information that is each accessed by an input wager,
the random number generator configured so that a probability of accessing the first information through an input wager is higher than a probability of accessing the second information through an input wager,
the processor programmed to identify: a) one return for an input wager that accesses the first information; and b) a second return for an input wager that accesses the second information,
the second return higher than the one return,
wherein the processor is programmed to factor in a percentage commission in identifying the one and second returns,
where the processor is programmed to factor in a higher percentage commission for the second return than a percentage commission for the one return.

2. A method of processing returns on wagers that are input to a random number generator to access different information in a wagering base, the method comprising the steps of:
receiving a plurality of input wagers;
processing the input wagers and identifying whether the input wagers access the information in the wagering base; and
identifying returns for first and second input wagers that respectively access first and second different information in the wager base,
the step of identifying a return further comprising factoring in a percentage commission that is different for the returns for the first and second input wagers.

3. The method of processing returns according to claim 2 wherein a probability of accessing the first and second different information is different for the first and second input wagers.
